(19) United States
(12) Patent Application Publication
(10) Pub. No.: US 2019/0176674 A1
(43) Pub. Date: Jun. 13, 2019

(54) HAND-TRIMMABLE VEHICLE FLOOR MAT

(71) Applicant: Higher Auto Accessories Co., Ltd., Sanmen (CN)

(72) Inventor: Bin Xu, Sanmen (CN)

(21) Appl. No.: 15/843,651

(22) Filed: Dec. 15, 2017

(30) Foreign Application Priority Data
Dec. 12, 2017 (CN) 201721466931.6

(51) Int. Cl. B60N 3/04

(52) U.S. Cl. CPC B60N 3/048

(57) ABSTRACT

A hand-trimmable vehicle floor mat has a footpad body and trim regions arranged around the footpad body. Each trim region can be detached by hand from the footpad body by a user without the user of any tools. The trim regions are separated from each other and from the footpad body by strip-shaped grooves. Each strip-shaped groove has a plurality of through holes that extend through the bottom of the strip-shaped grooves, the through holes sequentially arranged along an entire length of the strip-shaped grooves to provide perforated strip-shaped grooves. The plurality of trim regions can be torn away from the footpad body by hand and without the use of tools, the user applying a tearing force on the trim region to cause a tear along the strip-shaped groove.

### CROSS-REFERENCE TO RELATED APPLICATIONS

This application claims priority to Chinese Utility Model Application No. 201721466931.6 filed on Dec. 12, 2017, the entire contents of which are hereby incorporated by references and should be considered a part of this specification.

### BACKGROUND

### Field

The invention relates to a trimmable vehicle floor mat, and more particularly to a hand-trimmable or tearable vehicle floor mat.

### Description of the Related Art

Vehicle floor mats are very practical accessories, which may not only enhance the comfort of the driver, but also perform the functions of anti-slipping, cleaning and protecting the vehicle carpet. The traditional vehicle footpad or floor mat usually has a tread region and a covered edge having the function of providing better cooperation between the floor mat and the vehicle to fit the floor mat on an appropriate position. However, since the traditional floor mat is substantially designed and manufactured according to the vehicle models, that is, dedicated to the specific vehicle models, a footpad or floor mat cannot be applied to multiple vehicle models and it is not widely applicable, limiting the sales of a particular floor mat design to only the vehicles it is meant to fit.

As a result, new footpads or floor mats are designed to address the above problems. For example, trimmable floor mats have been introduced, such as Chinese patent publication number 202320004U, where the floor mat has trim regions defined by trim lines that a user can trim with scissors or cutting blades to change the outer profile of the floor mat to fit different vehicle models and to improve the application range of the footpad or floor mat. However, such floor mats require the user of tools to trim the mats, which is inconvenient, as users may not have the needed tools readily available.

### SUMMARY

Accordingly, there is a need for an improved vehicle footpad or floor mat that allows for easy trimming of the mat, without requiring the use of any tools, to fit a variety of vehicle models. In accordance with one aspect of the invention, a hand trimmable (e.g., tearable) footpad or vehicle floor mat is provided to change the shape of the vehicle footpad or floor mat without aid of cutting tools (e.g., scissors, blades, etc.).

In accordance with another aspect, a tearable footpad (e.g., floor mat) comprises a footpad body having one or more trimming regions arranged around the footpad body and several strip-shaped grooves arranged at least partially about the trimming regions, wherein, several through holes are arranged in the bottoms of the strip-shaped grooves, and the several through holes are arranged along the lengths of the strip-shaped grooves sequentially to define perforated strip-shaped grooves.

In accordance with another aspect, trim lines in the vehicle floor mat are defined by the plurality of strip-shaped grooves around the body of the footpad or floor mat, and the structural strength of the strip-shaped groove bottoms (e.g., base of the groove) is weakened by providing several through holes (e.g., perforations that extend completely through the floor mat body within the grooves) arranged sequentially along the length of the strip-shaped groove. Advantageously, when a user pulls with their hands on the trim region (e.g., pulls along one of the plurality of strip-shaped grooves) to apply a force on the trim region, the strip-shaped groove bottom is torn, so that trimming of the vehicle footpad or floor mat along one or more of the strip-shaped grooves can easily be done by hand without requiring the user of any tools. Accordingly, unnecessary regions of the vehicle footpad or floor mat can be torn by hand by the user to alter the outer profile of the body of the footpad or floor mat to fit the user's particular vehicle. Advantageously, such hand-trimmable footpad or floor mat makes the fitting of a trimmable floor mat simple and convenient for the user.

In accordance with another aspect, the through holes are strip-shaped holes (e.g., each of the through holes has a length greater than a width), where the length directions of the strip-shaped holes are the same with the length directions of the strip-shaped grooves, and the longitudinal center lines of the strip-shaped holes are on the longitudinal center lines of the strip-shaped grooves (e.g., the through holes defined on a stripped shaped groove share the same longitudinal center line with the strip-shaped groove). If the through holes are strip-shaped holes, more area of the strip-shaped groove bottoms is cut out. Advantageously, the strip-shaped holes have a guiding effect (e.g., guides the direction in which the trimmable sections tear when the user applies a pulling force on them), which enables the user to tear the unnecessary region from around the body of the footpad or floor mat more easily and conveniently.

In accordance with another aspect, the distance between two adjacent strip-shaped holes in a hand trimmable vehicle footpad or floor mat is less than the length of each strip-shaped hole. Such design allows for easy tearing for the connection between two adjacent strip-shaped holes (e.g., a force required to tear along the strip-shaped groove between two sequential strip-shaped holes is relatively less as compared to strip-shaped holes that are spaced farther apart).

In accordance with another aspect, the through holes are diamond shaped holes, where the longer diagonals (e.g., the longer dimension between two opposite corners) of the diamond holes are aligned on the longitudinal center lines of the strip-shaped grooves. The distance between two adjacent diamond shaped holes is less than or equal to the lengths of the longer diagonals of the diamond shaped holes. In such a way, during tearing by the user to trim the vehicle footpad or floor mat, the strip-shaped grooves may be easily torn since the sharp corners along the longer diagonals of the diamond shaped holes can guide the tearing direction, and additionally guide and concentrate the tearing force applied by the user while hand trimming the vehicle floor mat, concentrating the tearing stress from the applied force on the sharp corners of the longer diagonals of the diamond shaped holes.

In accordance with another aspect, the through holes in the trimmable vehicle footpad or floor mat can be round holes, where the centers of the round holes are aligned on the center lines of the strip-shaped grooves, and the distance between two adjacent round holes is less than or equal to the diameters of the round holes. The round holes can be formed in the strip-shaped grooves and the distance between round holes is less than the diameters of the round holes, so that more round holes can be arranged on the strip-shaped grooves and the strip-shaped grooves to allow for ease in tearing of the trimmable sections of the body of the footpad or floor mat by the user with their hands and without requiring any tools to trim the vehicle floor mat to fit the user's vehicle.

In accordance with another aspect, the connection of the footpad (or floor mat) body and the trimming region is arched up and forms an annular boss around the footpad body. The surrounding of the footpad body is arched up by arranging an annular boss, so that the footpad body is constructed in basin shape and the sewage (e.g., spilled liquid, garbage) and dust inside the footpad body will not fall into the interior space of the vehicle (e.g., the space of the footwell of the vehicle outside the border of the footpad or floor mat.

In accordance with another aspect, the hand trimmable (e.g., tearable) vehicle footpad or floor mat can have several shuttle-shaped anti-slip bumps arranged in the front side of the footpad body, the several anti-slip bumps optionally arranged in several lines, and the anti-slip bumps in the same line oriented in the same direction while the anti-slip bumps in two adjacent lines on either side of the same line oriented in a different direction. The anti-slip performance of the anti-slip bumps is effectively improved by arranging anti-slip bumps in the front side of the footpad body and making the anti-slip bumps in two adjacent lines have different orientations.

In accordance with another aspect, the hand trimmable (e.g., tearable) vehicle footpad or floor mat can have several anti-slip mechanisms, including at least one anti-slip emboss, arranged in the back side of the footpad body. The footpad can be positioned in the vehicle stably for preventing slipping thereof by arranging anti-slip mechanisms in the back side of the footpad body.

In accordance with another aspect of the hand trimmable (e.g., tearable) vehicle footpad or floormat, the anti-slip mechanisms optionally include four anti-slip embosses in a square arrangement. As the anti-slip mechanisms are composed of four anti-slip embosses, a claw-shaped structure formed for secure gripping on the vehicle carpet with a good anti-slip effect. Any number of anti-slip embosses can be adopted for various combinations to form anti-slip mechanisms.

In accordance with another aspect of the hand trimmable (e.g., tearable) vehicle footpad or floormat, several strip-shaped reinforcing bars are arranged in the back side of the annular boss, and the length directions of the reinforcing bars are perpendicular to the direction of the inner wall (e.g., medial wall) or outer wall (e.g., lateral wall) of the annular boss. Advantageously, the structural strength of the annular boss is improved by arranging reinforcing bars in this manner.

Compared with the prior art, the hand trimmable (e.g., tearable) vehicle footpad or floormat has the following advantages: (1) the trimmable portions can be easily and conveniently torn by the user using only their hands (i.e., without the need to use any tools, such as scissors or blades), (2) the hand trimmable vehicle footpad or floor mat can be applied and fits well with different vehicle models, and its arrangement is convenient, reliable and widely applicable (e.g., applicable to a variety of vehicles), and (3) the structure of the footpad or floor mat is simple and the strength of the footpad body is reliable, while also functioning to resist wear and preventing dust and trash from flowing around.

### BRIEF DESCRIPTION OF THE DRAWINGS

FIG. 1 is a top view of the front side of a hand trimmable (e.g., tearable) vehicle footpad or floor mat.

FIG. 2 is an enlarged view of section A of the footpad in FIG. 1.

FIG. 3 is a top view of the back side (e.g., a bottom view) of the tearable footpad of FIG. 1.

FIG. 4 is an enlarged view of an alternative structure of the through holes of a tearable footpad.

FIG. 5 is an enlarged view of an alternative structure of the through holes of a tearable footpad.

### DETAILED DESCRIPTION

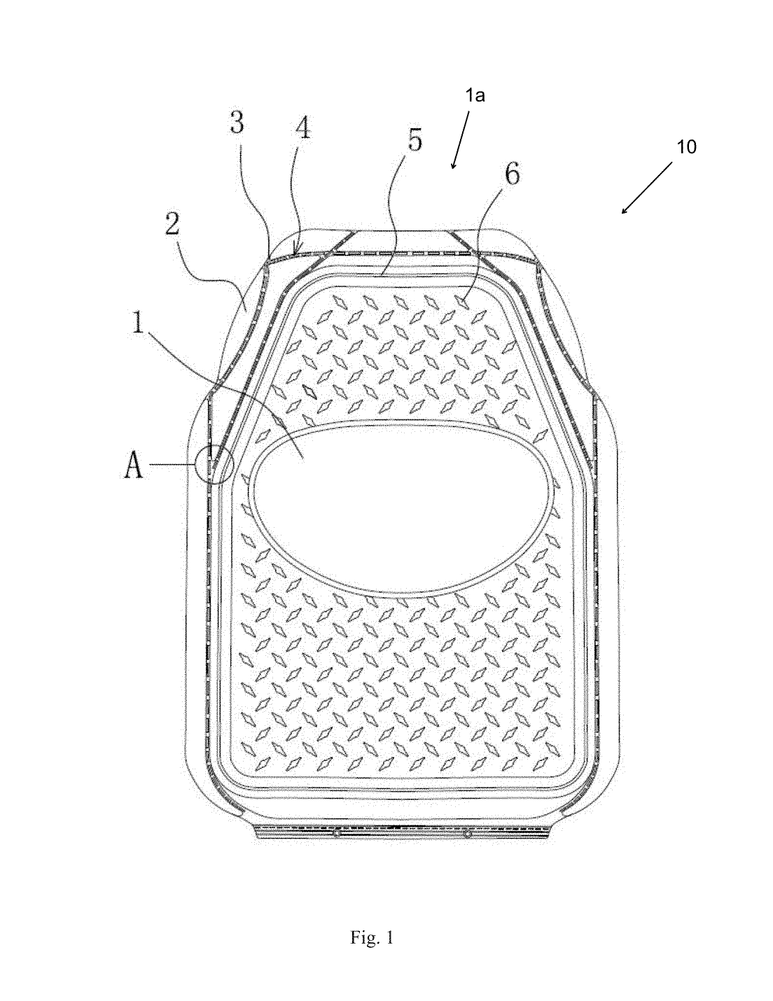

As shown in FIG. 1, a hand-trimmable (e.g., tearable) vehicle footpad or floor mat 10 has a footpad body 1 that includes one or more trim regions 2 (e.g., tearable or removable regions) arranged around the footpad body 1. The footpad 10 also has one or more (e.g., a plurality of) strip-shaped grooves 3 arranged so as to at least partially bound the one or more trim regions 2. Optionally, the strip-shaped grooves 3 can have a width W1 of approximately 3-4 mm. Optionally, the strip-shaped grooves 3 can have a depth of approximately 1-2 mm. A plurality of through holes 4 are arranged along the bottom surface of each of the strip-shaped grooves 3, the through holes 4 extending through (e.g., completely through) the thickness of the bottom of the strip-shaped grooves 3 to define perforated strip-shaped grooves 3. Optionally, the plurality of through holes 4 can be strip-shaped holes 4a (e.g., holes having a length greater than a width) arranged in the bottoms of the strip-shaped grooves 3. Optionally, the strip-shaped holes 4a have a length L of approximately 6-7 mm. Optionally, the strip-shaped holes 4a have a width W of approximately 1 mm. The connection between the footpad body 1 and the one or more trim region 2 is arched up (e.g., raised relative to the footpad body 1) and optionally defines an annular boss 5 around the footpad body 1. Optionally, the annular boss 5 has a height of approximately 5-7 mm above the surface of the footpad body 1. The footpad or floor mat 10 can be made of any suitable flexible material for floor mats (e.g., rubber).

The footpad 10 can optionally have a plurality of shuttle-shaped anti-slip bumps 6 arranged on the front side (e.g., top side) of the footpad body 1. Optionally, the anti-slip bumps 6 have a height of 5-6 mm above the surface of the footpad body 1. Optionally, the anti-slip bumps 6 have a length of approximately 25 mm. The plurality of anti-slip bumps 6 are optionally arranged in a plurality of rows. Optionally, the anti-slip bumps 6 in each row are oriented in the same direction, while the anti-slip bumps 6 in two adjacent lines on either side of said row are optionally oriented in a different direction.

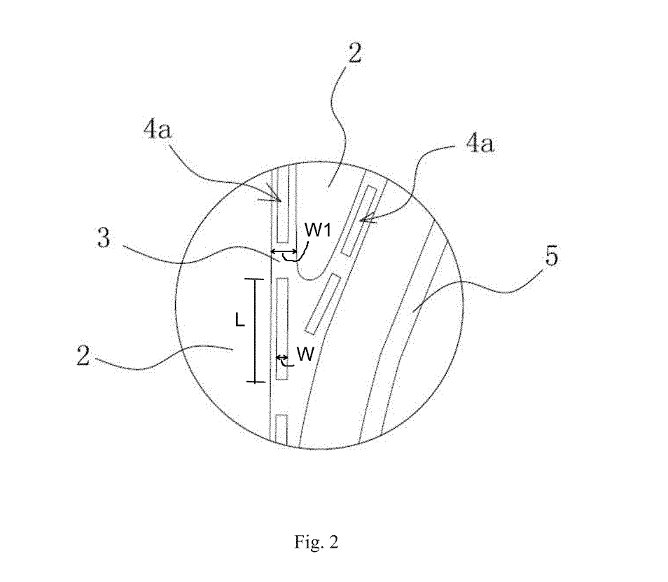

Specifically, as shown in FIG. 2, several strip-shaped holes 4a are arranged along the lengths of the strip-shaped grooves 3. The longitudinal direction of the strip-shaped holes 4a coincide (e.g., are aligned and extend along) the longitudinal direction of the strip-shaped grooves 3. The longitudinal center lines of the strip-shaped holes 4a coincide (e.g., are aligned with) the longitudinal center lines of the strip-shaped grooves 3. Advantageously, the distance between two adjacent strip-shaped holes 4a is less than the length of each strip-shaped hole 4a. For example, the distance between two adjacent strip-shaped holes 4a is less than ½ the length of each strip-shaped hole 4a. In another example, the distance between two adjacent strip-shaped holes 4a is less than ⅓ the length of each strip-shaped hole 4a. In still another example, the distance between two adjacent strip-shaped holes 4a is less than ¼ the length of each strip-shaped hole 4a. Such design advantageously allows easy tearing (e.g., by the user with their hands) of the connection between two adjacent strip-shaped holes 4a and requires less force to effectuate such tearing. Optionally, the plurality of strip-shaped holes 4a have substantially the same dimensions (e.g., length, width). Optionally, a thickness of the strip-shaped groove 3 (e.g., between a bottom surface of the groove on the top surface of the footpad 10 and a bottom surface of the footpad 10) is approximately 1 mm.

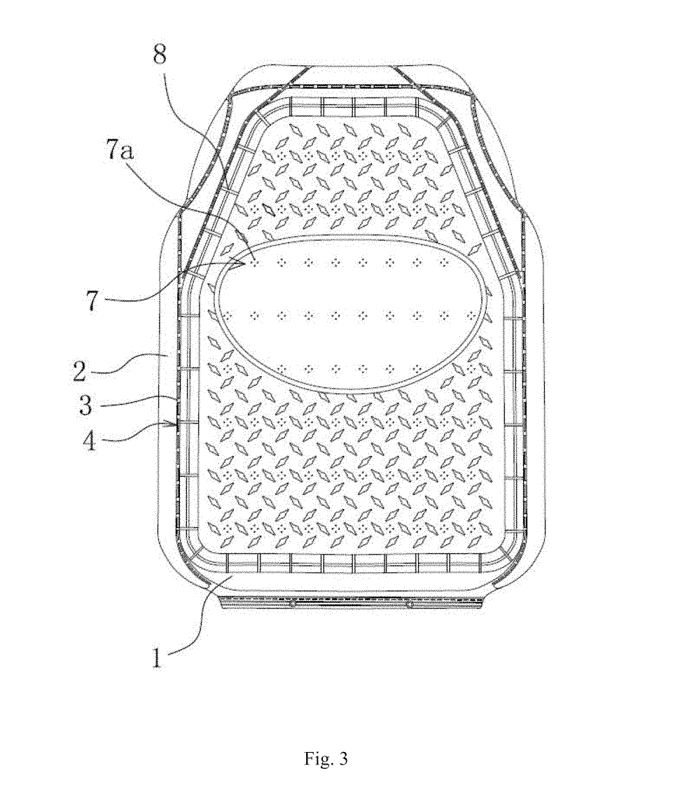

As shown in FIG. 3, several anti-slip mechanisms 7 are arranged in the back side of the footpad body 1. The anti-slip mechanisms 7 can facilitate positioning of the footpad 1 on the vehicle footwell and optionally include at least one anti-slip emboss 7a to aid in keeping the footpad 1 substantially in place in the vehicle footwell. Each of the anti-slip mechanisms 7 optionally has four anti-slip embosses 7a. The anti-slip embosses 7a are optionally in a square arrangement. Any number of anti-slip embosses 7a can be incorporated on the back side of the footpad body 1, and in various combinations, to form anti-slip mechanisms 7.

With continued reference to FIG. 3, one or more (e.g., a plurality of) strip-shaped reinforcing bars 8 are arranged in the back side of the annular boss 5, and longitudinal directions of the reinforcing bars 8 are substantially perpendicular to a longitudinal direction of the annular boss 5 (e.g., a longitudinal direction of the inner wall (medial wall) or outer wall (lateral wall) of the annular boss 5). The reinforcing bars 8 advantageously improve the structural strength of the annular boss 5.

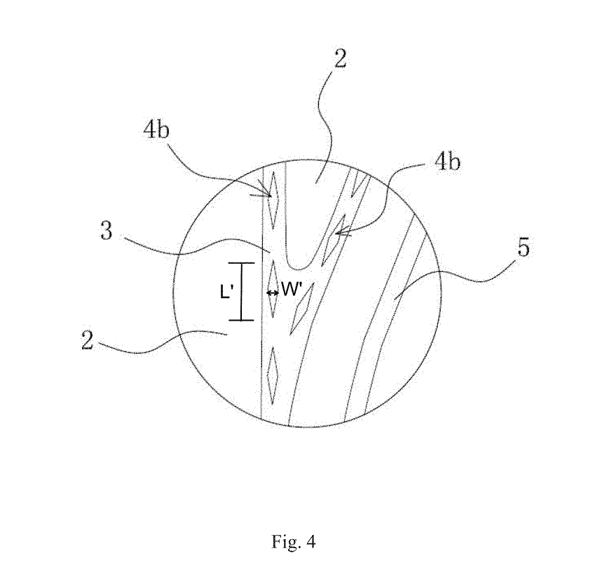

FIG. 4 shows features of an alternative vehicle footpad or floor mat 10, which is identical to the floor mat 10 described above in connection with FIGS. 1-3, except as described below. FIG. 4 shows an alternative shape of the through holes 4 arranged along the bottom surface of each of the strip-shaped grooves 3 of the footpad 10. Specifically, the through holes 4 are diamond-shaped holes 4b, where the longer diagonals (e.g., the larger dimension between opposite corners) of the diamond-shaped holes 4b are aligned with or extend along the longitudinal center lines of the strip-shaped grooves 3. Optionally, the diamond-shaped holes 4b have a length L′ of approximately 5-7 mm. Optionally, the diamond-shaped holes 4b have a width W′ of approximately 1-3 mm. The distance between two adjacent diamond-shaped holes 4b is less than or equal to the lengths of the longer diagonals of the diamond-shaped holes 4b. For example, the distance between any two adjacent diamond-shaped holes 4b is less than or equal to ½ the lengths of the longer diagonals of the diamond-shaped holes 4b. In another example, the distance between any two adjacent diamond-shaped holes 4b is less than or equal to ⅓ the lengths of the longer diagonals of the diamond-shaped holes 4b. In still another example, the distance between two adjacent diamond-shaped holes 4b is less than or equal to ¼ the lengths of the longer diagonals of the diamond-shaped holes 4b. In such a way, during tearing of the trim sections 2 by the user (using only their hands to do so), the strip-shaped grooves 3 may be easily torn since the sharp corners along the longer diagonals of the diamond shaped holes 4b advantageously help to guide the tearing direction, and guide and concentrate the tearing force to concentrate the tearing stress on the sharp corners between which the length of the longer diagonals are defined.

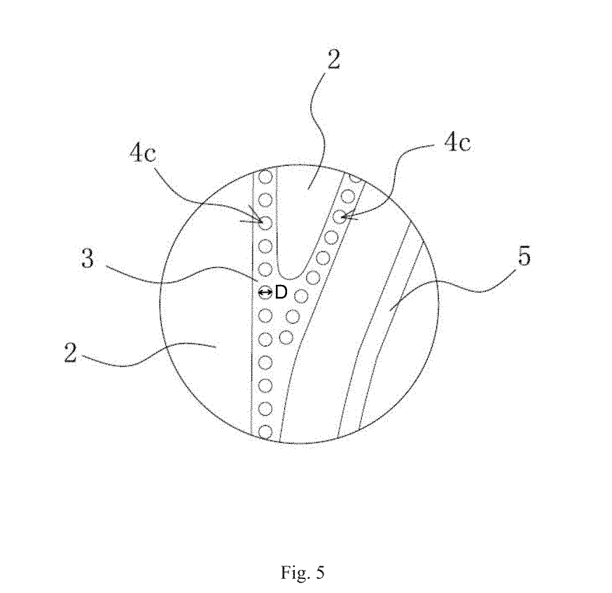

FIG. 5 shows features of an alternative vehicle footpad or floor mat 10, which is identical to the floor mat 10 described above in connection with FIGS. 1-3, except as described below. FIG. 5 shows an alternative shape of the through holes 4 arranged along the bottom surface of each of the strip-shaped grooves 3 of the footpad 10. Specifically, the through holes 4 are round holes 4c, where the centers of the round holes 4c are centered on the longitudinal center lines of the strip-shaped grooves 3. Optionally, the round holes 4c have a diameter D of approximately 1-2 mm. The distance between any two adjacent round holes 4c is less than or equal to the diameters of the round holes 4c. For example, the distance between any two adjacent round holes 4c is less than or equal to ½ the diameters of the round holes 4c. In another example, the distance between any two adjacent round holes 4c is less than or equal to ⅓ the diameters of the round holes 4c. In still another example, the distance between two adjacent round holes 4c is less than or equal to ¼ the diameters of the round holes 4c. Such an arrangement advantageously allows more through holes 4 to be arranged on the strip-shaped grooves 3, and can further facilitate the tearing of the strip-shaped grooves 3 (e.g., by hand by the user, and without the user of tools) to remove the trimming sections 2 to tailor the footpad or floor mat 10 to the user's particular vehicle.

With reference to the vehicle footpad or floor mat 10 described above in connection with FIGS. 1-5, the plurality of through holes 4 sequentially arranged on the bottom of the strip-shaped grooves 3 advantageously provide for a weakened structural strength of the bottoms of the strip-shaped groove 3. Such a weakened structural strength of the strip-shaped grooves 3 allows a user to tear away (using only their hands, without the need for any tools) the trim region 2 by applying a pulling or tearing force (e.g., draw outwardly with force on the trim region 2). This results in the tearing off of the trim region 2 along the bottoms of the strip-shaped groove 3 and along the arrangement direction of the through holes 4. Accordingly, the unnecessary trim region 2 can be torn and removed by the user using only their hands (without requiring the user of any tools) to fit the footpad or floor mat 10 to the user's vehicle (e.g., car). The perforated strip-shaped grooves 3 therefore advantageously provide a simpler and more convenient way for a user to trim the footpad or floor mat 10 as needed to fit the user's vehicle (e.g., car). Additionally, the spacing of the through holes (e.g., distance between adjacent through holes being less than length of the through hole) advantageously facilitates the ease in tearing the trim region 2 away from the rest of the car mat body, but also advantageously results in the remaining trimmed edge of the car mat being substantially even (e.g., substantially linear). Advantageously, the footpad or floor mat 10 has a plurality of trim regions 2, which allow the user to alter one or more of an overall width of the floor mat 10, an overall length of the floor mat 10, and a contour shape of a distal end 1a of the floor mat 10, thereby allowing the floor mat 10 to be customized by the user for use with a variety of different vehicles having different shaped footwells.

While certain embodiments of the invention have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A hand-trimmable vehicle floor mat, comprising:
a footpad body;
a plurality of trim regions arranged around the footpad body, each of the trim regions being selectively detachable by hand from the footpad body by a user, the plurality of trim regions separated from each other and from the footpad body by one or more strip-shaped grooves,
each of the strip-shaped grooves including a plurality of through holes that extend through the bottom of the strip-shaped grooves, the plurality of through holes sequentially arranged along an entire length of the strip-shaped grooves to provide perforated strip-shaped grooves,
wherein the plurality of trim regions are configured to be torn away from the footpad body by hand and without the use of tools, the user applying a tearing force on the trim region to cause a tear along the strip-shaped groove.

2. The vehicle floor mat of claim 1, wherein the plurality of through-holes are strip-shaped holes having a length greater than a width, a longitudinal direction of the strip-shaped holes being aligned with a longitudinal direction of its corresponding strip-shaped groove, a longitudinal centerline of the strip-shaped holes being substantially co-axial with a longitudinal centerline of its associated strip-shaped groove.

3. The vehicle floor mat of claim 2, wherein a distance between opposing ends of adjacent strip-shaped holes is less than the length of either of said adjacent strip-shaped holes.

4. The vehicle floor mat of claim 1, wherein the plurality of through-holes are diamond-shaped holes having a length greater than a width, a longitudinal direction of the diamond-shaped holes being aligned with a longitudinal direction of its corresponding strip-shaped groove, a longitudinal centerline of the diamond-shaped holes being substantially co-axial with a longitudinal centerline of its associated strip-shaped groove.

5. The vehicle floor mat of claim 4, wherein a distance between opposing ends of adjacent diamond-shaped holes is less than the length of either of said adjacent diamond-shaped holes.

6. The vehicle floor mat of claim 1, wherein the plurality of through-holes are round holes, a center of the round holes being aligned with a longitudinal direction of its corresponding strip-shaped groove, and the center of each of the round holes being aligned with a longitudinal centerline of its associated strip-shaped groove.

7. The vehicle floor mat of claim 2, wherein a distance between opposing ends of adjacent round holes is less than a diameter of either of said adjacent round holes.

8. The vehicle floor mat of claim 1, further comprising a raised annular boss arranged around the footpad body and that connects the footpad body with one or more of the plurality of trim regions.

9. The vehicle floor mat of claim 8, further comprising a plurality of strip-shaped reinforcing bars arranged on a back side of the annular boss, the strip-shaped reinforcing bars extending in a longitudinal direction substantially perpendicular to a direction of an inner wall or outer wall of the annular boss.

10. The vehicle floor mat of claim 1, further comprising a plurality of shuttle-shaped anti-slip bumps arranged on a top surface of the footpad body, the plurality of anti-slip bumps being arranged in a plurality of lines, where the anti-slip bumps in a same line are oriented in one direction and the anti-slip bumps in two adjacent lines on either side of the same line are oriented in a second direction different than the first direction.

11. The vehicle floor mat of claim 1, further comprising a plurality of anti-slip mechanisms arranged on a bottom surface of the footpad body, each anti-slip mechanism having at least one anti-slip emboss.

12. The vehicle floor mat of claim 11, wherein each anti-slip mechanism includes four anti-slip embosses in a square arrangement.

13. A hand-trimmable vehicle floor mat, comprising:
a footpad body;
a plurality of trim regions arranged around the footpad body, each of the trim regions being selectively detachable by hand from the footpad body by a user, the plurality of trim regions separated from each other and from the footpad body by one or more strip-shaped grooves,
each of the strip-shaped grooves including a plurality of strip-shaped through holes having a length greater than a width and that extend through the bottom of the strip-shaped grooves, the plurality of strip-shaped through holes sequentially arranged along an entire length of the strip-shaped grooves to provide perforated strip-shaped grooves,
wherein the plurality of trim regions are configured to be torn away from the footpad body by hand and without the use of tools, the user applying a tearing force on the trim region to cause a tear along the strip-shaped through holes.

14. The vehicle floor mat of claim 13, wherein a longitudinal direction of the strip-shaped through holes is aligned with a longitudinal direction of its corresponding strip-shaped groove, a longitudinal centerline of the strip-shaped through holes being substantially co-axial with a longitudinal centerline of its associated strip-shaped groove.

15. The vehicle floor mat of claim 13, wherein a distance between opposing ends of adjacent strip-shaped through holes is less than the length of either of said adjacent strip-shaped through holes.

16. The vehicle floor mat of claim 13, further comprising a raised annular boss arranged around the footpad body and that connects the footpad body with one or more of the plurality of trim regions.

17. The vehicle floor mat of claim 17, wherein the annular boss comprises a plurality of strip-shaped reinforcing bars arranged on a back side of the annular boss, the strip-shaped reinforcing bars extending substantially perpendicular to a direction of the annular boss.

18. The vehicle floor mat of claim 13, further comprising a plurality of shuttle-shaped anti-slip bumps arranged on a top surface of the footpad body, the plurality of anti-slip bumps being arranged in a plurality of rows, where the anti-slip bumps in a same row are oriented in one direction and the anti-slip bumps in two adjacent rows on either side of the same row are oriented in a second direction different than the first direction.

19. The vehicle floor mat of claim 13, further comprising a plurality of anti-slip members arranged on a bottom surface of the footpad body, each anti-slip member having a plurality of anti-slip embosses.

20. The vehicle floor mat of claim 19, wherein the plurality of anti-slip embosses are arranged in a square shape.
